(19) United States
(12) Patent Application Publication
(10) Pub. No.: US 2016/0250954 A1
(43) Pub. Date: Sep. 1, 2016

(54) Headrest Safety Mechanism and Method of Use

(71) Applicant: Andres Gomez, Houston, TX (US)

(72) Inventor: Andres Gomez, Houston, TX (US)

(21) Appl. No.: 14/633,509

(22) Filed: Feb. 27, 2015

(51) Int. Cl. B60N 2/48

(52) U.S. Cl. CPC B60N 2/4879

(57) ABSTRACT

A headrest safety system and method of use with a base, a middle strap, an insert, and a back strap. The head safety mechanism can be placed around an existing headrest to add support and comfort for a user and prevent head movement during rest or sleep.

### CROSS-REFERENCE TO RELATED APPLICATIONS

Not applicable.

### STATEMENT REGARDING FEDERALLY SPONSORED RESEARCH

Not applicable

### BACKGROUND

The present invention, and inventive system, is a new and novel invention that works as a head restraint for use on a chair, or supportive mechanism that has a headrest. By way of example, when there are passengers in cars, vehicles or other devices with preexisting headrests there is the natural human tendency to fall asleep or rest. At such times, a standard safety belt and shoulder strap will hold the upper torso while the head is free to roll onto the neck and to rest on the shoulders, or in other uncomfortable positions. Resting in this position can cause severe discomfort when the passenger awakens and/or damage the head and/or neck if an accident occurs. The present invention is designed to be a portable headrest safety mechanism that can slip over an existing headrest and gently keep the head in place on the headrest safety mechanism thereby preventing neck pain, trauma or injury due to an unsupported head.

The present inventive head supporting safety mechanism is a product that can solve the uncomfortable and awkward problem that children and adults can experience when they fall asleep on a chair or in a vehicle, airplane, or other seat with a head rest.

The present invention came into existence when the inventor looked in the rearview mirror and witnessed helplessly as the inventor's children were in odd and extremely uncomfortable positions after falling asleep. The present invention solves the problem of head security that pillows, stuffed animals, and other products have due to mobility and lack of stability of these items.

The present invention can provide support for a child and/or adult that has inadvertently dozed off in a vehicle and is confronted with the particular predicament of having the head unsupported. The present invention is a product that is comfortable, simple, durable, safe, affordable, and most importantly effective. The present invention can provide people with the peace of mind to situate their family member in a stable and agreeable position as they journey to their destination or utilize the invention on any surface with a headrest or backing.

The present invention is easy to setup and to operate. The present invention can be attached on the head rest of any chair, whether in the home or in vehicle, plane, or train and while the user is awake, they will not even know it is there until the user needs it. Once the user is falling asleep, the user, or another individual, can place the middle loop of the present invention over the user's forehead and the user is then maintained in an upright position with no leaning into awkward and agonizing positions.

The present invention is readily distinguished from the prior art in the field. The present invention is patentably distinct from US Pat. App. 20110043025A to Park entitled “Cervical Support Harness Assembly” because the present invention has a head cushion base and the present invention is less restrictive on a user as the present invention only has one head strap. The present invention also differs from US Pat. App. 20110043025A because the present invention attaches to the head rest of a seat and not directly to a child car seat. The present invention does not have a “U” shape neck brace and the head strap of the present invention connects to the base and not directly to the seat. The present invention also differs because the user can easily place the middle strap of the present invention in order to engage the device.

The present invention varies from US Pat. App. 2013/0020853A1 to Gibson entitled “Secure Me System” because the present inventive system has a head cushion base and US Pat. App. 2013/0020853A1 does not. The present inventive system further differs from US Pat. App. 20130020853A1 because the head strap connects to the base in the present system and not directly to the seat.

The present invention varies from US Pat. App. 2013/0146723A1 to Johnson entitled “Head Supporting Apparatus” because the present invention has a head cushion base. The present invention also differs from US Pat. App. 2013/0146723A1 because it does not have a “U” shape neck brace and because the head strap connects to the head cushion base in the present invention and not directly to the seat.

The present invention varies from U.S. Pat. No. 2,267,103A to Ireland entitled “Head Support” because the present invention has a one piece head cushion base, while U.S. Pat. No. 2,267,103A has two pieces for head cushions. The present invention's head cushion base straps to the seat head rest, while in U.S. Pat. No. 2,267,103A there is the need for a metal rod insert.

### SUMMARY

In several embodiments of the present invention, the present invention operates under several parameters.

In many embodiments of the present invention, the present invention comprises: a base, a middle strap, an insert, and a back strap. In several embodiments of the present invention, the base may be composed of a woven type of material, such as a cotton type material, or any other pliable material that can be have adherent material on it. In some embodiments of the present invention the insert can be made from foam and hard plastic.

In several embodiments of the present invention the base may be comprised of a bottom with a side flap opening. In several embodiments of the present invention, the base can form a hollow pouch for carrying an insert. In several embodiments of the present invention the base has at least two horizontal openings on a front face and two on the back face. In several embodiments of the present invention, these openings substantially align with one another. In several embodiments there are two egress slits on the top side of the base. In several embodiments of the present invention one top strap, which can be Nylon or other strap material, may be inserted through the egress slits on the top side of the base. In several embodiments of the present invention the top side of the base may have a top strap attached to it by mechanical attachment such as, but not limited to, being sewn on. In several embodiments of the present invention the top strap may be in two attached pieces.

In several embodiments of the present invention the top strap may be comprised of cotton, nylon, or any other suitable strap material. In several embodiments of the present invention, the top strap can have two distal ends designed to join with each other and form a mechanically disengagable loop. In several embodiments of the present invention the top strap can be in two pieces which are attached to distal corners of the top portion of the base by an adhesive material through methods known in the industry such as, but not limited to, sewing, glue, or soldering. In several embodiments of the present invention the ends of the straps distal to the base can comprise any well-known mechanical engagement devices such as, but not limited to clamps, snaps, or hook and loop mechanical attachment methods and devices.

In several embodiments of the present invention the base could be composed of one solid piece of material. In several embodiments of the present invention the base is hollow and forms a pouch in which can be put an insert. In several embodiments of the present invention the insert is comprised of a material that is impact absorbent as well as firm, such materials may include but are not limited to semi pliable plastics and premolded solid foams, or paddings. In several embodiments of the present invention the insert may be comprised of two or more materials that are adhered to each other such as a semisolid foam and/or prepackaged gel attached to a solid backing made of plastic, acrylic, wood or other solid materials.

In several embodiments of the present invention there is a middle strap. In several embodiments of the present invention the middle strap may be comprised of cotton, nylon, or any other suitable strap material. In several embodiments of the present invention, the middle strap can have two distal ends designed to join with each other and form a mechanically disengageable loop. In several embodiments of the present invention the distal ends of the straps can comprise any well-known mechanical engagement devices such as, but not limited to clamps, snaps, or hook and loop mechanical attachment methods and devices. In several preferred embodiments of the present invention, the middle strap is preferably designed with a soft material middle section on the middle strap that will preferably contact with the forehead of an end user while the inventive device is in operation.

In many embodiments of the present invention present invention is assembled in substantially the following manner. The insert is placed into the base through the Side flan opening when said. opening is open. In some embodiments of the present invention the insert is placed so that the semi-pliable material will be facing the inside of the base closest to the users head and be the primary material between the head and the solid base of the insert. In some embodiments of the present invention the positioning of the insert materials can be reversed depending on the end users comfort level. in many embodiments of the present invention, the side flap opening is then closed with the insert in it. In several embodiments of the present invention the top strap is then inserted through the egress slots and the middle strap is woven through the openings such that the middle strap will extrude through the openings in the front face of the base. In several embodiments of the present invention the middle strap is woven through the openings such that the middle strap will extrude through the openings in the front face of the base and the top strap is then inserted throught the egress slots.

In many embodiments of the present invention the present invention may be used in substantially the following manner. After the present invention is assembled, the present invention is brought to a chair or device with a headrest. In several embodiments, the device is then placed over the headrest such that the top strap goes over the head rest. In several embodiments of the present invention the top strap is adjustable such that the present invention is firmly attached to the headrest. In several preferred embodiments of the present invention the base is attached to the headrest such that the soft pliable materials of the insert are facing away from the headrest, as are the ends of the middle strap. In several embodiments of the present invention, when the user wishes to engage the present invention, all they need to do is the place the back of their head on the base, when seated, and attach the middle strap ends around their forehead thereby securing them to the base.

In one embodiment, the present invention is a headrest safety system comprising: a hollow base with a top and with a front face and a back face; said hollow base further comprising two slots in the front face and the back face and a side flap opening; a top strap; said top strap has adjustable length; a middle strap with two ends; said middle strap has adjustable length and an insert with two slots; wherein said insert is placed into said hollow base through said side flap opening; said top strap is mechanically attached to said hollow base at the top of said hollow base; and said middle strap is woven through one slot of said front face of said hollow base, one slot of said insert with two slots, out the slot of the back face of the base, through the other slot of the said back face of the base, through the other slot of said insert with two slots, and out the other slot of said front face of said hollow base, such that the two ends of said middle strap are connect away from the base. In some embodiments of the present invention the headrest safety system further comprises said top strap in two parts each attached to the top portion of said base on opposite sides. In some embodiments of the present invention the headrest safety system further comprises said middle strap with two ends is facing out of the front face of the base. In some embodiments of the present invention the headrest safety system further comprises a middle strap with two ends is facing out of the back face of the base. In some embodiments of the present invention the headrest safety system further comprises said insert has a hardback face and a pliable face.

In one embodiment the present invention is a method for creating a headrest safety system comprising the steps of: obtaining a hollow base with a front face and a back face; said hollow base further comprising two slots in the front face and the back face and a side flap opening; obtaining a top strap; obtaining a middle strap with two ends; and obtaining an insert with two slots; placing said insert into said hollow base through said side flap opening; attaching said top strap to the top of said hollow base; and weaving said middle strap through said one slot of said front face of said hollow base, one slot of said insert with two slots, out the slot of the back face of the base, through the other slot of the said back face of the base, through the other one slot of said insert with two slots, and out the other one slot of said front face of said hollow base, such that the two ends of said middle strap are facing out of the base. In some embodiments of the present invention the method of creating a headrest safety system further comprises said top strap in two parts each attached to the top portion of said base on opposite sides. In some embodiments of the present invention the method of creating a headrest safety system further comprises said middle strap with two ends is facing out of the front face of the base. In some embodiments of the present invention the method of creating a headrest safety system further comprises said middle strap with two ends is facing out of the back face of the base. In some embodiments of the present invention the method of creating a headrest safety system further comprises said insert has a hardback face and a pliable face.

In one embodiment the present invention is a method for using a headrest safety system comprising the steps of: obtaining a headrest system comprising: a base with a front face and a back face; said base further comprising two slots in the front face and the back face, and a side flap opening; a top strap; a middle strap with two ends; and an insert with two slots; wherein said insert is placed into said hollow base through said side flap opening; said top strap is attached to the top of said hollow base; and said middle strap is woven through said one slot of said front face of said hollow base, one slot of said insert with two slots, out the slot of the back face of the base, through the other slot of the said back face of the base, through the other slot of said insert with two slots, and out the other one slot of said front face of said hollow base, such that the two ends of said middle strap are facing out of the front face of the base; and placing said headrest system on a chair or device with a preexisting headrest such that the top straps encircle the preexisting headrest and hold the headrest safety system firmly. In some embodiments of the present invention, the present invention is a method of using headrest safety system further comprising: said top strap is in two parts each attached to the top portion of said base on opposite sides. In some embodiments of the present invention, the present invention is a method of using headrest safety system further comprising: said middle strap with two ends is facing out of the front face of the base. In some embodiments of the present invention, the present invention is a method of using headrest safety system further comprising: said middle strap with two ends is facing out of the back face of the base. In some embodiments of the present invention, the present invention is a method of using headrest safety system further comprising: said middle strap is refitted around an end users head prior to actual use. In some embodiments of the present invention, the present invention is a method of using headrest safety system further comprising: said insert has a hardbacked face and a pliable face.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 illustrates one embodiment of the present invention in assembled view.

FIG. 2 illustrates one embodiment of the present invention in an exploded view.

FIG. 3 illustrates one embodiment of the present invention partial side view attached to a headrest.

FIG. 4 illustrates one embodiment of the present invention as being utilized by an end user.

FIG. 5 illustrates one embodiment of the present invention as single molded piece with attachment mechanisms on the straps.

### DETAILED DESCRIPTION

In the following description, certain details set forth such as specific quantities, sizes, etc. . . . so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale.

One, or more, illustrative embodiments incorporating the invention disclosed herein are presented below. Applicants have created a revolutionary and novel system and method of a headrest safety mechanism and method of use.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 11th Edition, 2008. Definitions and/or interpretations should not be incorporated from other patent applications, patents, or publications, related or not, unless specifically stated in this specification or if the incorporation is necessary for maintaining validity.

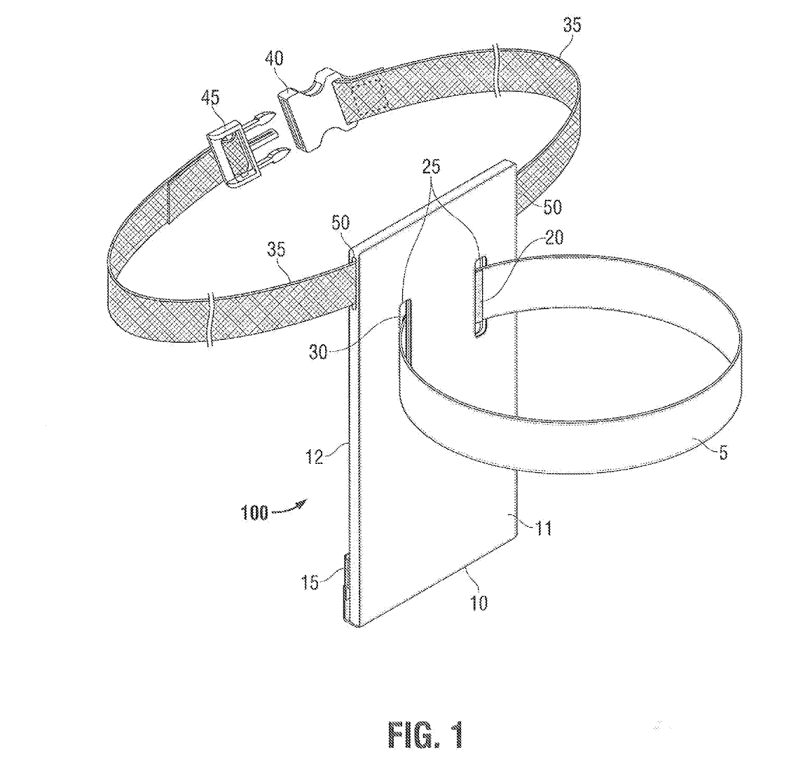

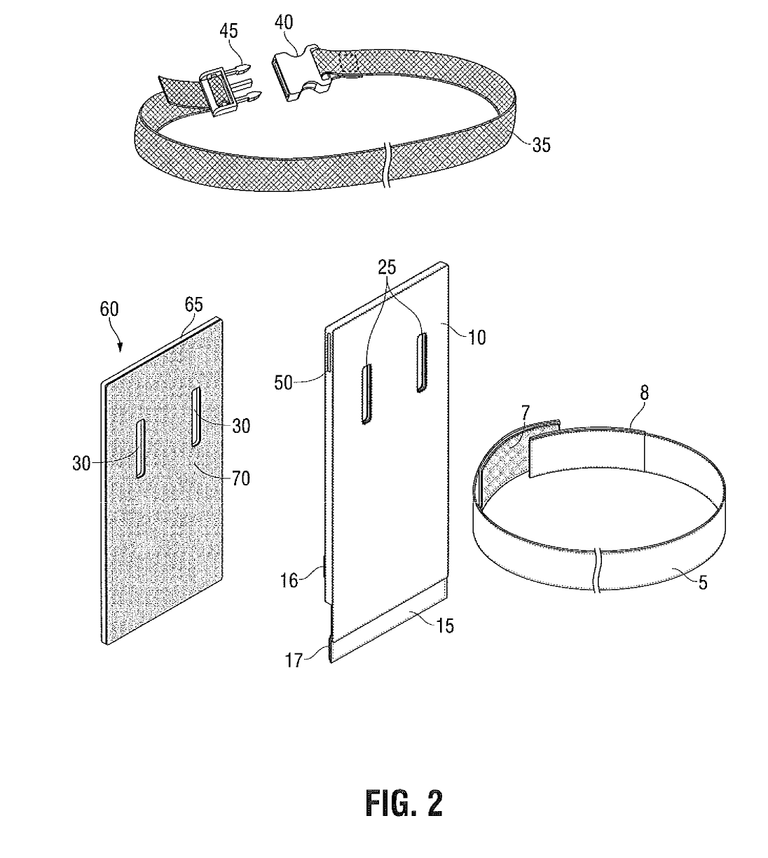

FIG. 1 shows one embodiment of the present invention in an assembled view. As illustrated the headrest system 100 is preferably composed of several parts. The base 10 is preferably composed as to be pouch in general shape, although other shapes may be used in the industry. The base 10 is preferably constructed with a front face 11 and a back face 12. Base 10 is preferably constructed with a moisture resistant material, such as, but not limited to, plastic or woven fibers. Base 10 is preferably constructed with a hollow interior area. In many embodiments of the present invention, base 10 is constructed with two slots 25 that are on the front face 11 and the back face 12. In several preferred embodiments the slots 25 are parallel and can also be substantially aligned so that the slots 25 are aligned and materials can pass through them. In several embodiments of the present invention the two slots 25 are horizontal. Base 10 may also be designed, in some embodiments, with a bottom side flap 15. As shown (FIG. 2) the side bottom flap 15 may utilize an attachment system such as a hook 17 and loop 16 system, or other system as is known in the art, therein being able to close the pouch of base 10 when the invention is fully assembled. It is envisioned that other attachment systems other than hook 17 and loop 16 can be used on the bottom side flap 15.

As shown in FIG. 1 in some embodiments of the invention, the upper strap 35 can be sewn or mechanically attached to ports 50 on the base 10. In other embodiments of the present invention ports 50 are open and the upper strap 35 can traverse through the interior of base 50 (See FIG. 2). Also illustrated are the slots 25, which when the device is assembled may have the middle strap 5 traverse through them such that the middle strap 5 will form a loop through the slots 25.

FIG. 1 also illustrates the upper strap 35 of some embodiments of the present invention. Upper strap 35 is preferably constructed with two mating clasps distal to the base 10. Male clasp 45 and female clasp 40 are illustrated as a buckle, but it is envisioned that any other type of adherence materials such as buckle, hook and loop, snap or clasp as is known in the art could be used. As illustrated in FIG. 1, upper strap 35 is actually in two parts joined at base 10, it is envisioned that upper strap 35 can be of one piece and loop through base 10 via the ports 50 in other embodiments (See FIG. 2.)

FIG. 1 also illustrates the middle strap 5 of the present invention. Middle strap 5 has two ends, as shown hook 7 and loop 8 (See FIG. 2.) As shown the middle strap 5 is designed to weave through the slots 25 of the base 10 and form a loop with the largest length proximate to the front face 11 of the base 10. In some embodiments of the present invention, the middle strap 5 can attach by other methods know in the art, The middle strap 5 can be made of a pliable elastic material such as nylon, woven fibers, or cloth. Also illustrated is the back adherence materials 20 such as buckle, hook and loop, snap or clasp as is known in the art. As illustrated the adherence materials 20 are of a hook 7 and loop 8 design. Partially illustrated in FIG. 1 (and more so in FIG. 2) are the slots 30 on the insert 60. In several embodiments of the present invention the adherence materials can be proximate to the back face 12. In several embodiments of the present invention the adherence materials can be in front of the front face 11. Both the middle strap 5 and the upper strap 35 are adjustable for length as is known in the art.

FIG. 2 illustrates one embodiment of the present invention in exploded form. As illustrated the hook 7 and loop 8 of middle strap 5 are preferably designed to attach (when assembled) proximate to the back face 12 of the base 10. In alternate embodiments, the hook 7 and loop 8 of middle strap 5 are preferably designed to attach (when assembled) in front of the front face 11 of the base 10. Also illustrated on base 10 is the bottom side flap 15 in open position. As illustrated the adherence materials for the bottom side flap 15 are of a hook 17 and loop 16 design although, other adherence methods such as a buckle, snap, or clasp as is known in the art maybe used.

FIG. 2 also illustrates insert 60. In some embodiments of the present invention insert 60 may be constructed of a soft but solid material such as a plastic, solid resin or acrylic in one molded piece. As illustrated in FIG. 2 the insert 60 is comprised of a front face 70 of pliable soft material such as a gel pack, an air pack, or some soft carbon based material. Front face 70 is preferably adhered to a solid back face 65 of the insert 60. Solid back face 65 may be constructed of metal, wood, plastic or other solid backing materials as is known in the art. Further illustrated on insert 60 are the slots 30 which preferably run parallel to each other in many embodiments, and through the entirety of insert 60. The slots 30 can be horizontal and match the length of slots 25, in some embodiments of the present invention. FIG. 2 also illustrates one embodiment of the top strap 35 as on solid piece that run through the base 10 when assembled.

In one embodiment of the present invention, the present invention is assembled in the following manner. The base 10 is opened such that the hook 17 and the loop 16 of the bottom side flap 15 are not in mechanical adherence (FIG. 2). The insert 60 is then inserted into the base 10, preferably such that the slots 25 and 30 will align when the base 10 is closed about the bottom side flap 15. In some embodiments of the present invention the front face 70 is inserted such that it faces the front face 11 of the base 10. Alternatively, the front face 70 can be inserted in some instances such that it faces away from the front face 11 of the base 10. In some embodiments the top strap 35 can then be threaded through the slots 50 of the base 10 (FIG. 2). In some embodiments of the present invention the top strap 35 and the middle strap 5 can be attached in any method known in the art. In other embodiments of the present invention the top strap 35 is preattached to the top of the base 10 (FIG. 1). The middle strap 5 is attached by weaving said middle strap 5 through said one slot 25 of said front face of the base 10, through one slot 30 of said insert 60, out the slot of the back face 12 of the base 10, through the other slot 25 of the back face of the base 10, through the other slot 30 of the insert 60, and out the other one slot 25 of the front face 11 of the base 10, such that the two ends of said middle strap 5, hook 7 and loop 8 are facing out of the front face 11 of the base. In another embodiment of the present invention the two ends hook 7 and loop 8 are facing out of the back face 12 of the base.

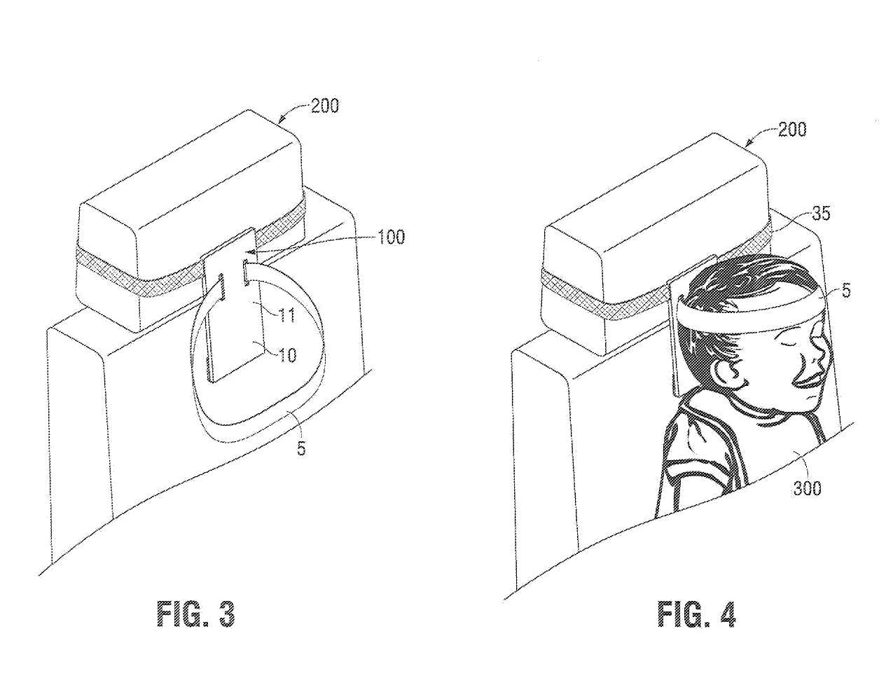

FIG. 3 illustrates one embodiment of the present invention attached to a headrest 200 such as could be found on a chair or a seat in a car or other vehicle. As shown the upper strap 35 is attached around the headrest 200 and firmly secured and tightened by the clamps 40 and 45 in a manner as known in the art. The base 10 has its front face 11 forward and the middle strap 5 is secured with hook 7 and loop 8 attachments behind the base 10. As shown, the present invention is attached around the soft headpiece of the headrest although it is envisioned that in some circumstances it could be attached around the metal stanchions that hold the headrest in place.

FIG. 4 illustrates one embodiment of the present invention in operation. As illustrated as user (in this case a child) 300 is utilizing the present invention by having the middle strap 5 secured around his head thereby impeding any slumping neck movements during sleep or rest on the headrest. In many preferred embodiments of the present invention, the middle strap 5 is pre-sized on the user before application (like a baseball cap) so that the middle strap 5 cannot slip past the forehead of a user 300 when in application. In some embodiments of the present invention, the user can be fitted and can adjust the middle strap 5 if the adherence materials 20 are in front of the front face 11. When the present invention is not in operation, the strap 5 can rest comfortably behind the user 300 head and then flipped quickly and safely over the user 300 head when the device is to be actuated. It is also envisioned that in some applications the adherence materials 20 can be located in the user's 300 forehead for quick readjustments on a new user.

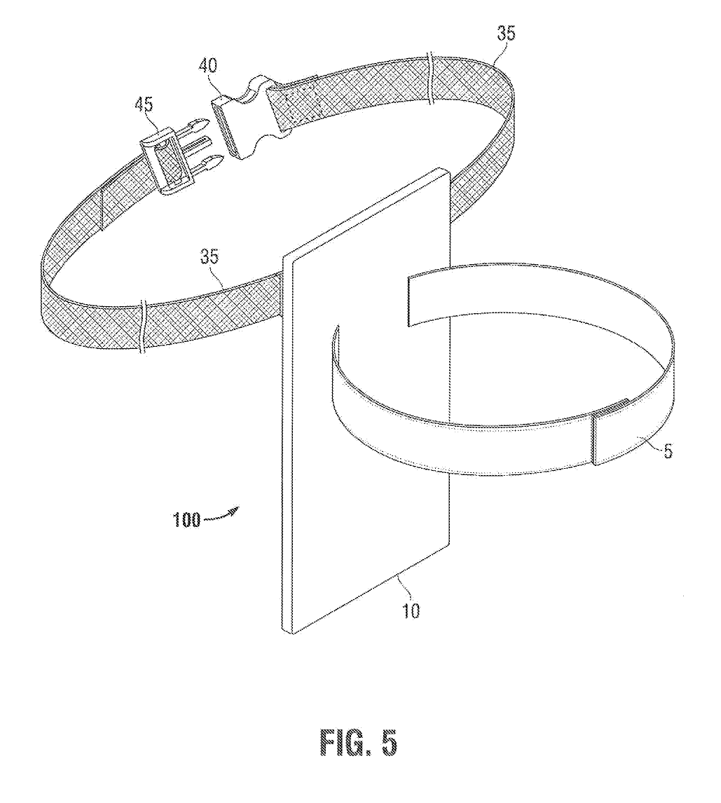

FIG. 5 illustrates one embodiment of the present invention as a premolded piece. The headrest system 100 in this embodiment is premolded with a solid base 10. As illustrated the middle strap 5 is already premolded to the base 10, although in other embodiments the strap 5 maybe attached to base 10 in any manner known in the art. In several embodiments the middle strap 5 can be either premolded or attached to base 10 at a variety of locations. Also illustrated is upper strap 35 which can be premolded, or attached, to base 10 at a variety of locations. It is envisioned that the attachment mechanisms for the upper strap 35 or the middle strap 5 can be of those types previously disclosed and described for FIGS. 1 and 2.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

1. A headrest safety system comprising:
a hollow base with a top and with a front face and a back face;
said hollow base further comprising two slots in the front face and the back face and a side flap opening;
a top strap;
said top strap has adjustable length.
a middle strap with two ends;
said middle strap has adjustable length and
an insert with two slots;
wherein said insert is placed into said hollow base through said side flap opening;
said top strap is mechanically attached to said hollow base at the top of said hollow base; and
said middle strap is woven through said one slot of said front face of said hollow base, one slot of said insert with two slots, out the slot of the back face of the base, through the other slot of the said back face of the base, through the other slot of said insert with two slots, and out the other slot of said front face of said hollow base, such that the two end of said middle strap with two ends are facing out of the base.

2. The headrest safety system of claim 1 further comprising:
said top strap is in two parts each attached to the top portion of said base on opposite sides.

3. The headrest safety system of claim 1 further comprising:
said middle strap with two ends is facing out of the front face of the base.

4. The headrest safety system of claim 1 further comprising:
said middle strap with two ends is facing out of the back face of the base.

5. The headrest safety system of claim 1 further comprising:
said insert has a hardback face and a pliable face.

6. A method for creating a headrest safety system comprising the steps of:
obtaining a hollow base with a front face and a back face;
said hollow base further comprising two slots in the front face and the back face and a side flap opening;
obtaining a top strap;
obtaining a middle strap with two ends; and
obtaining an insert with two slots;
placing said insert is placed into said hollow base through said side flap opening;
attaching said top strap to the top of said hollow base; and
weaving said middle strap through said one slot of said front face of said hollow base, one slit of said insert with two slots, out the slot of the back face of the base, through the other slot of the said back face of the base, through the other one slot of said insert with two slots, and out the other one slot of said front face of said hollow base, such that the two end of said middle strap with two ends are facing out of the base.

7. The method of creating a headrest safety system of claim 6 further comprising:
said top strap is in two parts each attached to the top portion of said base on opposite sides.

8. The method of creating a headrest safety system of claim 6 further comprising:
said middle strap with two ends is facing out of the front face of the base.

9. The method of creating a headrest safety system of claim 6 further comprising:
said middle strap with two ends is facing out of the back face of the base.

10. The method of creating a headrest safety system of claim 6 further comprising:
said insert has a hardback face and a pliable face.

11. A method for using a headrest safety system comprising the steps of:
obtaining a headrest system comprising:
a hollow base with a front face and a back face;
said hollow base further comprising two slots in the front face and the back face, and a side flap opening;
a top strap;
a middle strap with two ends; and
an insert with two slots;
wherein said insert is placed into said hollow base through said side flap opening;
said top strap is attached to the top of said hollow base; and
said middle strap is woven through said one slot of said front face of said hollow base, one slit of said insert with two slots, out the slot of the back face of the base, through the other slot of the said back face of the base, through the other one slot of said insert with two slots, and out the other one slot of said front face of said hollow base, such that the two end of said middle strap with two ends are facing out of the front face of the base; and
placing said headrest system on a chair or mechanical with a preexisting first headrest such that the top straps encircle the preexisting first headrest and hold the headrest safety system firmly.

12. The method of using headrest safety system of claim 11 further comprising:
said top strap is in two parts each attached to the top portion of said base on opposite sides.

13. The method of using headrest safety system of claim 11 further comprising:
said middle strap with two ends is facing out of the front face of the base.

14. The method of using headrest safety system of claim 11 further comprising:
said middle strap with two ends is facing out of the back face of the base.

15. The method of using headrest safety system of claim 11 further comprising:
said middle strap is refitted around an end users head prior to actual use.

16. The method of using headrest safety system of claim 11 further comprising:
said insert has a hardbacked face and a pliable face.
